(19) United States
(12) Patent Application Publication
(10) Pub. No.: US 2005/0175507 A1
(43) Pub. Date: Aug. 11, 2005

(54) Compliant, nanoscale free-standing multilayer films

(76) Inventor: Vladimir V. Tsukruk, Ames, IA (US)

Correspondence Address: Schwegman, Lundberg, Woessner & Kluth, P.A., P.O. Box 2938, Minneapolis, MN, 55402, US

(21) Appl. No.: 10/951,035

(22) Filed: Sep. 27, 2004

Related U.S. Application Data
(60) Provisional application No. 60/532,289, filed on Dec. 23, 2003.

(51) Int. Cl. G01N 15/06

(52) U.S. Cl. 422/68.1; 257/E51.023

(57) ABSTRACT

A compliant free-standing multilayer membrane is provided of the cross-sectional formula:
[(P_{cat}−Pₐₙ)ₙP_{cat}/Met/(P_{cat}−Pₐₙ)ₙP_{cat}]ₘ
wherein (P_{cat}31 Pₐₙ) represents a bilayer of an anionic polymer and a cationic polymer between at least one layer of Met; n is about 1-50, m is about 1-10; Met is an inert metal nanoparticle; P_{cat} is a cationic polymer and Pₐₙ is an anionic polymer, preferably prepared by a spin-assisted layer-by-layer assembly on a sacrificial substrate layer.

### CROSS-REFERENCE TO RELATED APPLICATION

The present application claims priority of U.S. provisional application Ser. No. 60/532,289, filed Dec. 23, 2003.

The present invention was made with the support of the United States Air Force, Contract No. F496200210205 and National Science Foundation Contract No. CTS0210005. The U.S. Government has certain rights in the invention.

### BACKGROUND OF THE INVENTION

The layer-by-layer (LbL) assembly^{[1]}, which is based on alternating electrostatic adsorption of oppositely charged materials (polyelectrolytes^{[1]}, dendrimers^{[2]}, proteins^{[3]}, clays^{[4]}, and nanoparticles^{[5,6]}), has been applied for the fabrication of a wide variety of functional ultrathin organized films.^{[7]} These films with tunable internal multilayered organization have potential applications in nanoelectronic, optoelectronic, and magnetic technologies, as well for opto-mechanical, chemical and bio sensing, and nanotribology.^{[8,9]}

Recently, a new approach of a spin self-assembly^{[10]} or spin-assembly^{[11]} was suggested, which combined the spin coating and LbL techniques to make a cost and time-efficient technology for the fabrication of multilayered films from polyelectrolytes, dendrimers, and inorganic nanoparticles on planar substrates.^{[10,11,12,13]} It has been shown that, in the framework of this approach, fast and efficient layer deposition under shear forces resulted in well-ordered multilayered structures with modest non-uniformity of the films and some properties different from “conventional” LbL films. However, this approach was not been used to fabricate multilayered, nanoparticle containing, truly nanoscale LbL films with exceptional mechanical parameters in the most demanding free-suspended or free-standing state where overall integrity and stability of the nanoscale films with macroscopic lateral dimensions play a critical role. Free standing organized organic-inorganic films are considered as prospective sensing compliant membranes for photo, opto, and thermal microdevices.^{[14]}

To date, several different approaches were implemented for the fabrication of free-standing nanoscale films from polymers and inorganic nanoparticles: cast films^{[15]1}, “growth from” reactions on the patterned surface^{[16]}, cross-linking of amphiphilic Langmuir films^{[17]}, and the deposition of the LbL multilayers onto a sacrificial or pH sensitive substrate.^{[18,19,20]} However, all these approaches included slow (from hours to days) and multistep routines, e.g., in Langinuir approach: monolayer formation, deposition, and crosslinking. Moreover, they multilayer LbL films are either limited to relatively thin 100-300 nm) polymer films or thick (300-5000 nm) composite organic-inorganic (with inorganic particles, platelets, fibers) films with uniformity issues. Usually, the thin LbL films are extremely fragile and corresponding composite films must be prepared relatively thick to accommodate filler irregularities. The mechanical characteristics achievable for these films are characterized by the elastic modulus values of several GPa and ultimate tensile strength of 40-70 MPa with a record value for carbon nanotube thick films of 220 GPa.^{[19]}

### SUMMARY OF THE INVENTION

The present invention provides a compliant, highly-uniform, extremely robust, smooth, and long-living free standing nanoscale membranes with excellent mechanical characteristics. The present membranes comprise two or more polyelectrolyte multilayers with a central interlayer containing gold nanoparticles (FIG. 1a) having a general cross-sectional formula: [(P_{cat}−Pₐₙ)ₙP_{cat}/Met/(P_{cat}−Pₐₙ)ₙP_{cat}]ₘ wherein P_{cat}−Pₐₙ represents a bilayer of a cationic polymer, such as an acid addition salt of a polyamine, and an anionic polymer, such as a polysulfonic acid salt, and Met is a nanoparticle of a metal such as silver or gold; preferably, m is 1-10 and n is 2-50 to yield a film thickness of about 20-500 nm, preferably about 15-250 nm, more preferably about 20-80 nm. Preferably, the membranes are formed by spin-assisted layer-by-layer assembly on a sacrificial substrate layer.

The central metal interlayer can be used in sensors to enhance an optical response and detect surface plasmon resonances from the deflected membranes as will be discussed hereinbelow. Uniform nanoscale films that have a thickness in the range from 20 to 70 nm, depending on the numbers of layers, can be constructed using with a spin-assisted layer-by-layer LbL (SA-LbL) assembly method. The films can be fabricated within several minutes unlike usual methods requiring several hours. The films of the invention can sustain significant, multiple elastic deformations with a life time of at least ten million cycles. The parameters achieved here (the elastic modulus of about 10-50 GPa, e.g., about 30-40 GPa, the ultimate strain of 2%, and the ultimate tensile strength of 130 MPa) surpass those known for much thicker (microns) nanoparticle-containing free standing LbL films.

The membrane of the present invention can be prepared by a process comprising depositing layers of the cationic polymer (P_{cat}), the anionic polymer (Pₐₙ), and the inert nanoparticles layer-by-layer using spin-assisted deposition, onto the surface of a substrate. Preferably the surface has been pre-coated by spin-assisted deposition of a layer of a nonionic polymer that is soluble in an organic solvent that does not dissolve Pₐₙ or P_{cat}, thus permitting the release of the film post-deposition, by simply dissolving the nonionic polymer. The nonionic polymer can be a polysaccharide, such as a cellulosic polymer, such as cellulose acetate, or other chemically-modified cellulose. The individual polymer layers can be crosslinked if necessary. The substrate can also be inorganic, such as a silicon wafer.

The present invention also provides a detection cell comprising a chamber formed by enclosing (or capping) a channel passing through a solid substrate at one end by a compliant membrane of the invention, and by enclosing (or capping) the channel at the other end by a rigid membrane that is transparent to the energy sought to be detected. The chamber can be cylindrical (the chamber walls can form a cylinder) or can be formed into other shapes as desired. The chamber can be filled with an inert gas such as argon, or with air.

The passage of the energy to be detected, such as photothermal energy, through the rigid membrane and into the chamber, causes a detectable elastic reversible deflection of the compliant membrane, which can be detected and measured by a suitably-placed detection means. The chamber or chambers can be about 0.1-10 μm in diameter, and can be formed as perforations in a planar substrate sheet such as a polysilicon sheet. Thus, a single solid substrate sheet can comprise a plurality of the detection cells of the invention. Preferably, the substrate sheet is about ≦100 nm in thickness. The membrane preferably possesses an elastic modulus of about 10-50 MPa, and can exhibit high absorption in the 8-12 μm wavelength range.

### BRIEF DESCRIPTION OF THE FIGURES

FIG. 1 a) Sketch of the microstructure of the free-standing film with a central gold nanoparticle intralayer sandwiched between two symmetrical polymer multilayers (n=3 is selected for illustration); b) large scale topographical image of (PAH-PSS)₇PAH/Au/PAH(PSS-PAH)₇ SA-LbL film on the silicon substrate; c) UV-vis spectrum for (PAH-PSS)₇PAH/Au/PAH(PSS-PAH)₇ demonstrating major adsorption bands caused by PSS adsorption as well as individual and collective surface plasmon resonances within gold nanoparticle intralayer; d) schematic of a free-suspended, highly compliant, multi-layered nano-scale membrane with layered nanoparticle/polymer organization deposited on a perforated substrate. Left: initial planar state. Right: membrane in deflected state, acting as a photo-thermally sensitive element.

FIG. 2 a) Large scale AFM image of (PAH-PSS)₃PAH/Au/PAH(PSS-PAH)₃ free-standing film released and lifted-up by a silicon substrate; b) height histogram and the AFM image of the released SA-LbL film edge used to obtain the thickness and microroughness of the film; c) high-resolution AFM topographical image of (PAH-PSS)₃PAH/Au/PAH(PSS-PAH)₃ free-standing film released and lifted-up by a silicon substrate; d) thickness of the SA-LbL free-standing films as a function of the number of polymer bilayers.

FIG. 3 a) Photograph of a released piece of (PAH-PSS)₇PAH/Au/PAH(PSS-PAH)₇ film on the water surface; b) Top view photograph of (PAH-PSS)₇PAH/Au/PAH(PSS-PAH)₇ SA-LbL film lifted-up by the 100 μm copper grid, several cells with broken film are indicated with white arrows; c, d) side view of the free-standing film that deformed by different pressures applied from below; e) the elastic deflection of the central part of 600 μm free-standing film under different pressure measured experimentally (squares) and a corresponding theoretical fit (line).

FIG. 4(a). Scheme of fabrication of gold nanoparticles-polyelectrolytes multilayers. a) assembly of PEI monolayer on a silicon wafer; b) gold nanoparticle monolayer deposited by adsorption on PEI surface; c) Au/(PAH-PSS)ₙPAH multilayers fabricated with SA LBL assembly of polyelectrolyte layers; d) assembly of [Au/(PAH-PSS)ₙPAH]₂ multilayer structure; FIG. 4(b). Scheme of fabrication of free-standing film.

FIG. 5. a) AFM topographical image of well-separated larger gold nanoparticles, diameter: 12.7±1.3 nm; b) AFM topographical image of smaller gold nanoparticles, diameter: 2.3±1.2 nm; c) height histogram of gold nanoparticles with the diameter of 12.7±1.3 nm obtained from AFM data; d) UV-visible extinction spectrum of larger and smaller gold nanoparticle solutions.

FIG. 6. AFM topographical images of gold nanoparticle monolayer with different surface coverage fabricated by using different concentrations of solution, z-scale is 30 nm: a) the lowest surface coverage obtained from 1.5×10⁻¹⁰ mol/L solution; b) low surface coverage of 2% obtained from 1.5×10⁻⁹ mol/L solution; c) the highest surface coverage of 22% obtained from 1.5×10⁻⁸ mol/L solution; d) larger scale area of same sample as c; e, f) high resolution topographical image (300×300 nm) of gold nanoparticles with surface coverage of 8% obtained with conventional silicon tip (e) and carbon nanotube tip (f). The appearance of nanoparticles is affected by the tip dilation, which is sensitive to a low point between particles reachable by the tip.

FIG. 7. Top: UV-visible extinction spectra of gold nanoparticle monolayers with different surface coverages. Bottom: the variation of positions of two resonance bands and their intensity ratio.

FIG. 8. AFM topography image and line scan profile of Au/(PAH-PSS)PAH multilayered films. a) large scale AFM image; b) higher resolution AFM image; c) AFM image of the film edge; d) cross-section of the image (c). Z scale is 30 nm.

FIG. 9. a) UV-visible extinction spectra of Au/(PAH-PSS)ₙPAH multilayers, with n of 1, 3 and 5, respectively. Gold nanoparticle surface coverage is 5%. b) The variation of plasmon resonance peak positions and their intensity ratio (the intensity of second to first plasmon peak).

FIG. 10. AFM topographical images of [Au/(PAH-PSS)₅PAH]₂ film, z-scale is 30 nm. a) higher-resolution image, b) large scale image; c) the variation of the film thickness for [Au/(PAH-PSS)ₙPAH]ₘ for different combinations of n and m. Two data points for m=3 are presented for illustrative purposes.

FIG. 11. Top: UV-visible extinction spectrum of [Au/(PAH-PSS)ₙPAH]₂ film with 22% gold nanoparticle surface density with three major adsorption bands marked. Bottom: a linear increase of the absorption at 225 nm with the bilayer number n.

FIG. 12. Top: UV-visible extinction spectra of [Au/(PAH-PSS)ₙPAH]₂ films with high gold nanoparticle density (22% surface coverage), with n equals to 1, 2, 3, and 4. These spectra can be fitted with three Lorentzian peaks, as shown for the n=1. Bottom: the variation of plasmon resonance peak positions and the intensity ratio (the intensity of second to first plasmon peak).

FIG. 13. Top: UV-visible extinction spectra of [Au/(PAH-PSS)ₙPAH]₂ films with medium gold nanoparticle density (15% surface coverage), with n equals to 0, 1, 2, 3, 4, and 5. Bottom: the variation of plasmon resonance peak positions and their intensity ratio (the intensity of second to first plasmon peak).

FIG. 14. Top: UV-visible extinction spectra of [Au/(PAH-PSS)ₙPAH]₂ films with different gold nanoparticle density. Bottom: the variation of plasmon resonance peak positions and their intensity ratio (the intensity of second to first plasmon peak).

FIG. 15. Microstructure of the film composed of two gold nanoparticles layers separated by three polymer layers, [Au/(PAH-PSS)₁PAH]₂, demonstrating different distance:diameter ratio for intralayer and interlayer distances and used for the estimation of total film thickness. It shows that for incomplete gold nanoparticles layers the thickness of the film with two gold nanoparticles layers is below a doubled value for a single layer.

FIG. 16. Scheme of apparatus for performing bulge test of supported film.

FIG. 17. Graph and photomicrographs demonstrating mechanical properties of free-standing films.

FIG. 18. Graph and diagram depicting micromechanical properties of free-standing films.

### DETAILED DESCRIPTION OF THE INVENTION

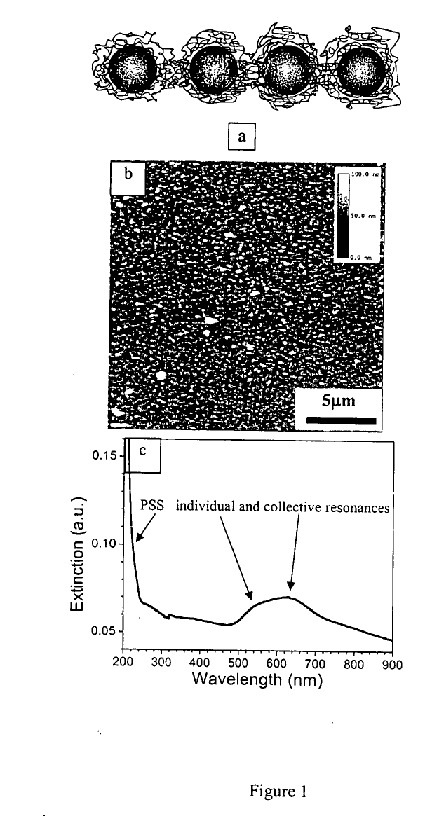

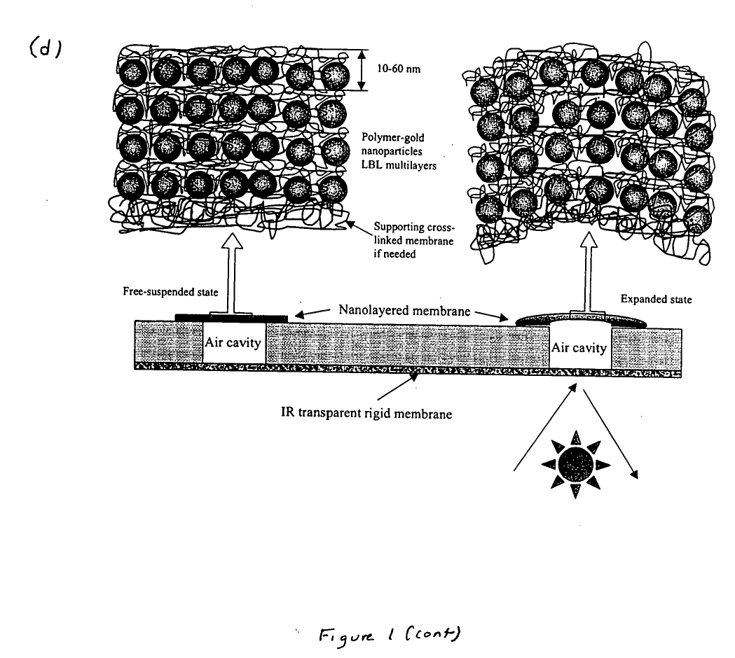

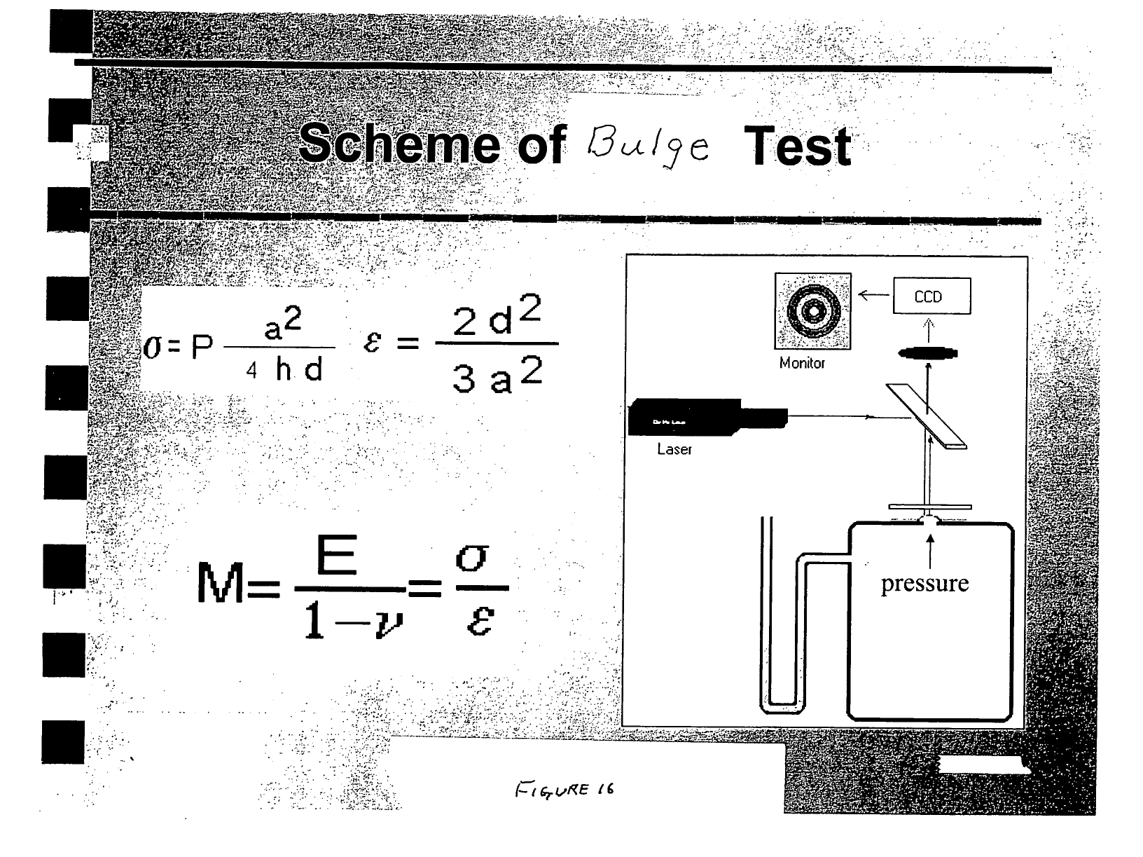

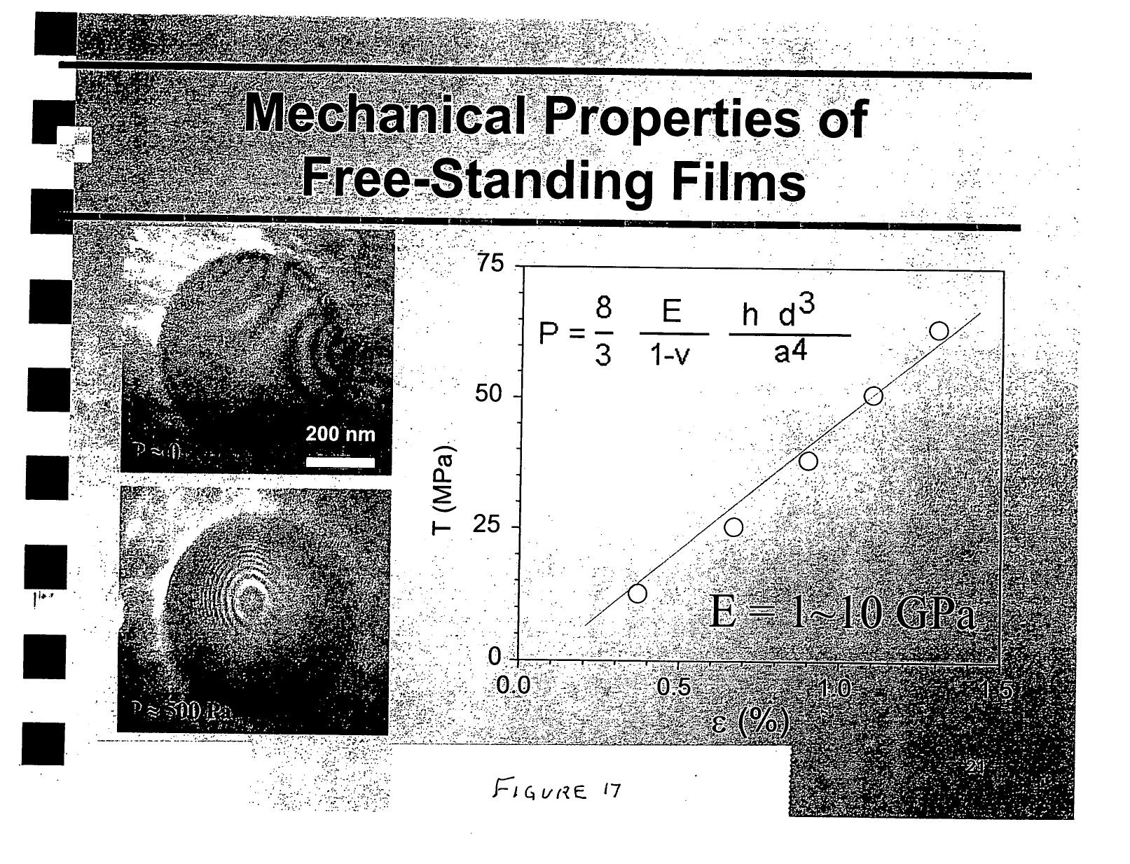

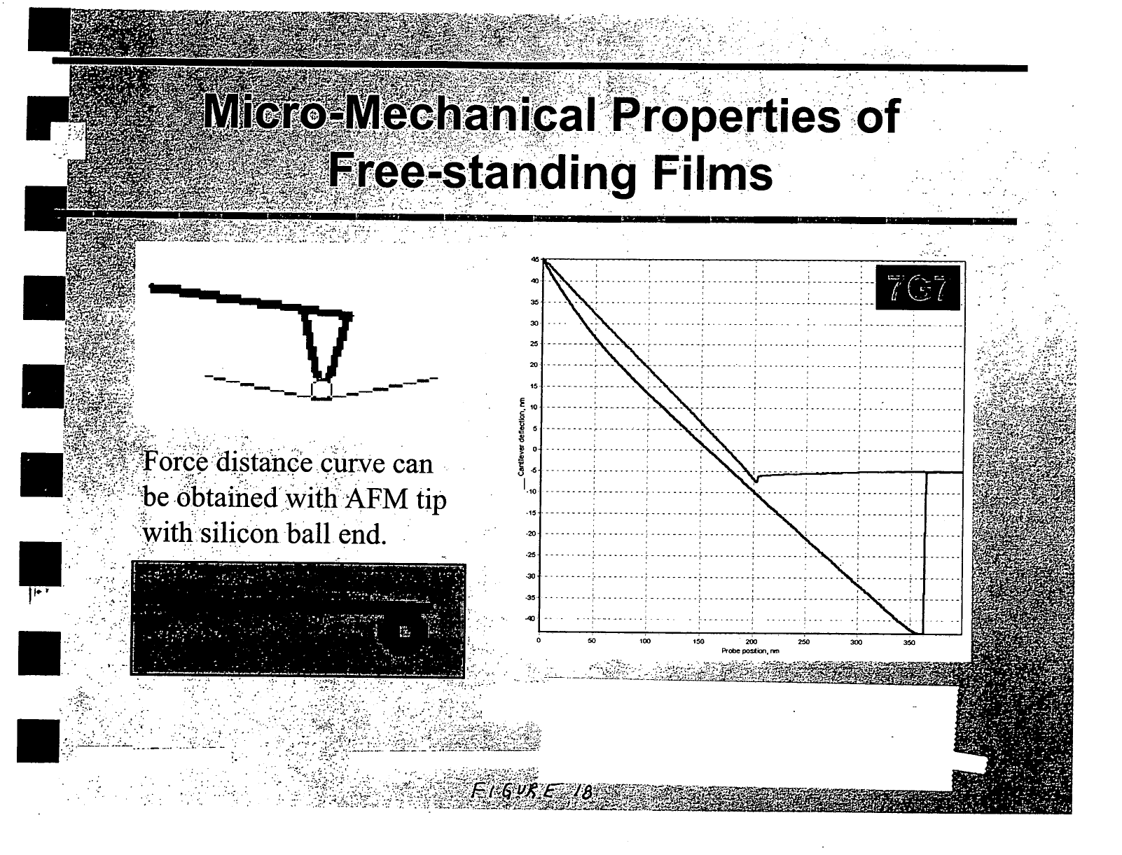

The major sensitive element in the sensor of the present invention is composed of highly compliant, ultrathin (40-400 nm), multilayered elastomeric membrane, with its supporting layer responsible for carrying external loads and providing a free-suspension/non-planar shape, if needed (FIG. 1d). The membrane's mechanosensitive layer is capable of significant reversible deformations, while providing the transduction of mechanical stresses to an external detector (FIG. 16). Initial spacing in the multi-nanolayered membrane can be established during the layer-by-layer fabrication process, with the deposition of alternating layers of nanoparticles and appropriately charged polymer electrolyte. Equilibrium spacing in the free-suspended state gives rise to a characteristic adsorption band in the visible range, which can be detected with UV-Vis spectroscopy. Stretching of the membrane is due to external stimuli (e.g., increasing air pressure in isolated cells of the perforated support (see FIG. 1d)). This leads to deviation from the initial planar configuration and changes of spacing in the multi-layered structure detectable via surface plasmon spectroscopy. Perforated solid substrates will be selected for their highly planar surfaces, with hole sizes of 0.1 to several tenths of a micrometers up to about 10 μm, and that can be assembled with thin and rigid bottom walls. Such substrates can be micro-fabricated from polysilicon.

Using the present compliant, multi-layered nanoscale membranes as a mechano- and thermosensitive element results in a great increase in the sensitivity of photo-thermal detection. Indeed, current silicon-based, microfabricated photo-thermal Golay cells are capable of detecting temperature gradients with the 0.2 K interval with a resolution surpassing 10⁻² K. Yamashita et al., Sensors & Activators A, 66, 29 (1998). A limiting factor is the brittleness of the silicon membrane, with a maximum deflection of 1 μm (0.03% elastic deformation), which limits the effective temperature window. In addition, the high bending modulus and capacitance detection limits the minimum detectable deflection and volume variation to values above 0.01%.

By contrast, large elastic (reversible) deflections of the sensing element can be easily observed for compliant polymer membranes with multi-nanolayered internal organization, thus expanding the detectable temperature window tremendously. W. A. Goedel et al., Langmuir, 14, 3470 (1998). For compliant membranes, temperature parameters may be estimated from the equation for pressure-deflection relationships in a free-suspended circular membrane:
ΔP=8 Eh (Δd)³/3(1−v)a⁴ (1)
where ΔP is pressure applied/detected, E is elastic modulus, h is membrane thickness, Δd is membrane deflection, a is membrane diameter, and v is Poisson's ration. V. W. Beems, in Structures and Properties of Thin Films, C. A. Neugebauer et al. eds.) John Wiley (1959) at page 183. Taking the typical dimensions of micro-fabricated Golay cells and the PVT relationship reported before with parameters for compliant materials (i.e., E=10 MPa, v=0.5), one may obtain a theoretical limit of about 10⁻⁵ K for the temperature sensitivity of the compliant membrane, which is several orders of magnitude better than for the present silicon-based Golay cells.

The present invention thus provides for the miniaturization of IR sensors down to a sub-micrometer scale. Indeed, the reduction of the membrane diameter, a, from a “microscopic” millimeter scale in current Si-based design inevitably results in a dramatic decrease in sensitivity, as defined by a given membrane deflection (see equation [1]). For instance, any attempt to miniaturize the silicon-based Golay cell, reducing its diameter to below about 10 μm, would result in increasing its bending stiffniess by six orders of magnitude, which in turn would make this “miniature” cell inoperable. Given that, for compliant, nanometer-thick membranes, the product Eh(Ad)³ in equation (1) can be reduced by 10-12 orders of magnitude, a manifold increase in sensitivity can be achieved, even for compliant membranes of 1 μm and less in diameter. Thus, this approach promises the prospect of “shrinking” the spatial dimensions of sensors to microscopic proportions, from the current 10⁻³ m and 10⁻⁶ m for lateral dimension and thickness, respectively, to 10 μm and <100 nm—a truly nanoscopic scale. This opens a new path for the microfabrication of an array of sensitive elements composed to provide IR imaging capability (FIG. 1d). Having an array of holes with individually suspended sensitive membrane elements, one may address the question of detecting the surface distribution of thermal gradients—and thus realize imaging capabilities unachievable with current Golay design.

Sensitivity limits and covered temperature ranges for Golay cells micro-fabricated with compliant membranes may be estimated using Yamashita's graphical analysis. For identical cell parameters and expanded, detectable deflection limits, one may estimate that minimum recognizable ΔT/Tₒ can be as low as 10⁻⁶, or ΔT=10⁻⁴K, and that the temperature window covered will expand to several degrees, instead of the 0.2 K in silicon-based designs of the cell.

The present compliant membranes preferably exhibit high linear elastic deformation to at least 20% (i.e., high bending deformation with linear response); low elastic modulus of 10-50 MPa (to provide low bending resistance at low external pressure); a high Poissson's ration of 0.5 (i.e., low tendency to plastic deformation); high yield strength (to assure low creep at high elastic deformation); and low thermal conductivity (for faster reaction on thermal flux). Secondary properties of the compliant membrane include optical transparency or reflectance (for effective optical detection), and high absorption in the 8-12 μm wavelength range (enhanced sensitivity). Polymers with chemical compositions appropriate for this design will be used as soft interlayers or first “template” layers for multi-nanolayered membranes.

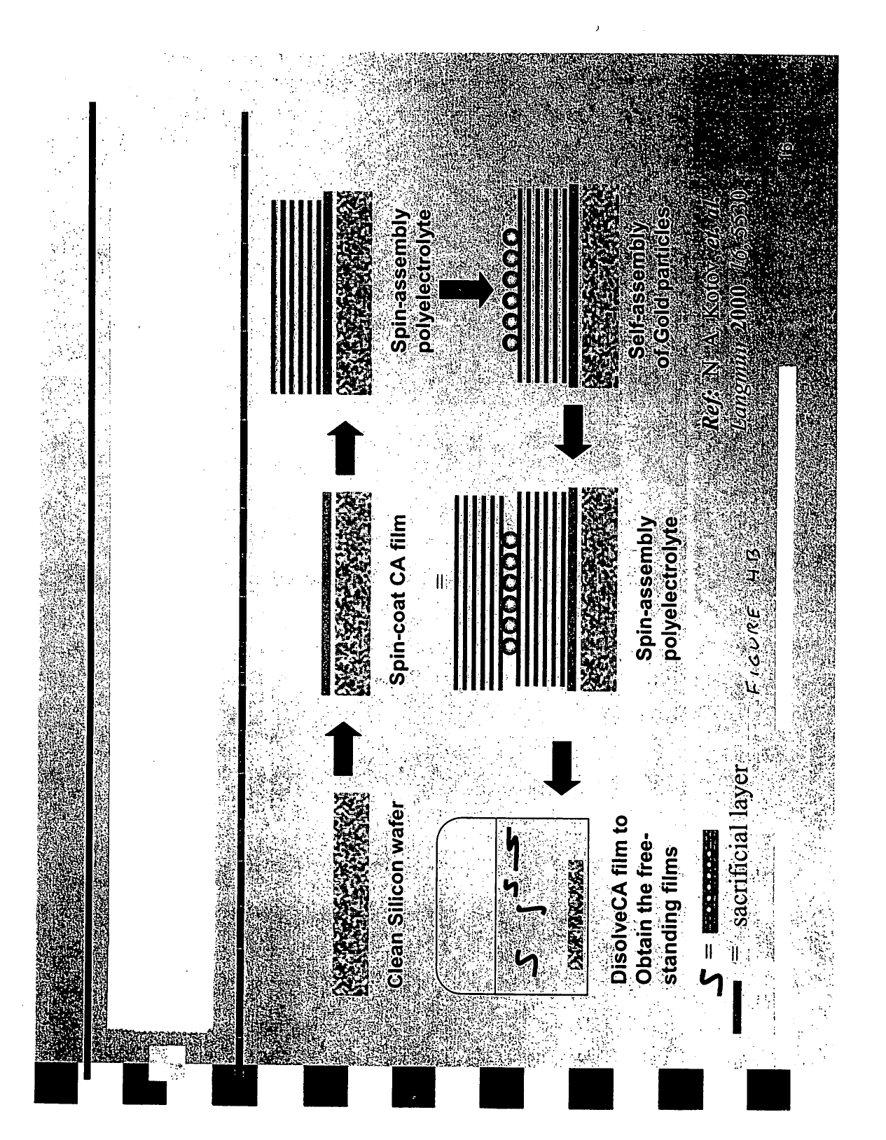

Another major element used to compose inorganic interlayers with distinguishable optical properties will be inorganic nanoparticles such as gold or silver. It is well known that that assemblies of inorganic particles (e.g., gold nanoparticles with diameters of 10-100 nm in dilute solution) show a strong absorption band in the UV-visible wavelength related to plasmon resonance. R. S. Reynolds et al., J. Amer. Chem. Soc., 122, 3795 (2000). (FIG. 5.) The position of this band depends upon diameter, the type of packing, and average inter-particle spacing. Organized assemblies from these nanoparticles in solution and in monolayer states show “signature” behavior controlled by level of aggregation. Layer-by-layer (LBL) techniques offer a versatile route to the creation of multi-layered films of nanoparticle materials with controllable composition and film thickness.

For free-suspended membranes with diameters of several micrometers, nanoscale defections will result in significant spacing changes within organized gold nanoparticle interlayers, which can cause a detectable shift of the absorption band on a scale of several nanometers. Optimization of the membrane microstructure in terms of its spacing, particle diameter, number of layers, and matrix compliance should result in increased detection capabilities. Currently, UV-visible spectroscopy is used for detecting the photo-chromic properties of organic monolayers as thin as 2 nm. If necessary, mechanochromic polymers can be included in the inner layer. Other approaches, such as surface plasmon spectroscopy, can be used to detect microstructural variations in the gold-containing interlayer. C. A. Mirkin, Inorg. Chem., 39, 2258 (2000). Mechanochromic polymers have conjugated bonds, and their photochromic response depends upon the conformational status of the macromolecular segments, which may be affected by local mechanical stress.

Alternatively, the compliant interlayer incorporating gold nanoparticle assemblies can be used as a highly reflective layer in a detection scheme based upon laser beam reflection principles. This scheme is widely used in highly sensitive instrumentation such as atomic force microscopes, and allows the detection of minute surface deflections on the scale of a fraction of a nanometer. D. Sarid, Scanning Force Microscopy, Oxford U. Press, New York (1991). The optical reflection scheme with photodiode array used currently for AFM experiments may be modified to measure the vertical deflection of free-suspended membranes. The possibility of a combined detection scheme (e.g., the reflection scheme for nanometer deflections and the absorption scheme for larger membrane deflections) is an option for implementing higher sensitivities and a wider range of detectable temperatures in future research based on this project.

Moderately excessive pressure within the cell will result in the non-planar, dome-like shape of the compliant membrane (FIG. 1d). Such a stressed state is much more sensitive to external variable pressure. Along with thermal flux variations, this non-planar shape can be explored for establishing a stress-mediated regime for the highest sensitivities. Conditions for membrane modulation close to its resonance frequency may be adjusted by varying chopper speed and the membrane's dimensions. Preliminary estimates by effective mass approach show that the principal mechanical resonance of compliant membranes may vary from several Hertz to several thousand Hertz. J. J. Hazel, Thin Solid Films, 339, 249 (1999). Periodic response will be detected in such a state, and any random fluctuations will be canceled out over several cycles. Free-suspended nanoscale membranes can be much more sensitive systems under such stressed conditions, and thus are susceptible to consistent external disturbances. In addition, a stressed membrane produced by controlled variation of excess pressure within the closed cell may maintain the stable, non-planar shape with micrometer-scale diameter, thereby serving as a microresonator for incoming electromagnetic radiation.

### EXAMPLE 1

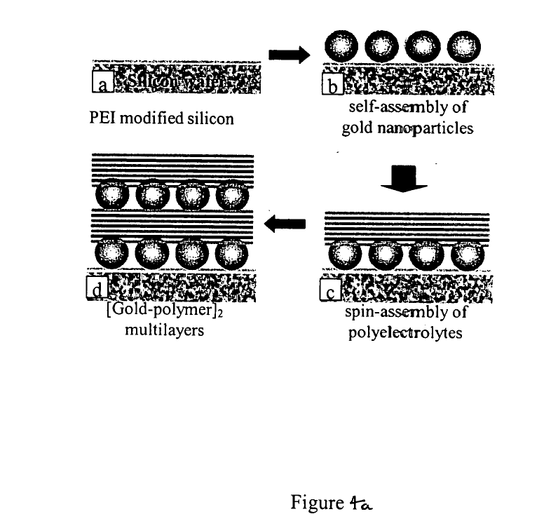

Gold nanoparticle-polymer multilayer films of the general formula (PAH-PSS)ₙPAH/Au/(PAH-PSS)ₙPAH which comprise a central gold nanoparticle layer covered with polymer multilayers (n=3-11) were fabricated by SA-LbL method (FIGS. 4a-b).

Gold nanoparticles (12.7±1.3 nm in diameter) were synthesized according to the known procedure.^{[24]} Resulting gold nanoparticles are slightly negatively charged and can be used for electrostatic LbL assembly as was demonstrated elsewhere.^{[25]} Polyelectrolytes, poly(ethylene imine) (PEI M_{w}=25,000), poly(allylamine hydrochloride) (PAH, M_{w}=65,000), and poly(sodium 4-styrenesulfonate) (PSS, M_{w}=70,000) were purchased from Aldrich and used as received. For SA-LBL deposition, PEI (1%), PAH (0.2%), and PSS (0.2%) solution were prepared with Nanopure water (18MΩ·cm). Silicon wafers with typical size 10×20 mm were immersed in piranha solution for 30 minutes and then rinsed throughout with pure water before used according to the usual procedure.^{[26]} For SA-LBL deposition the method described earlier was used^{[10,11]}: A 150 μL polymer solution was dropped onto the substrate and the substrate was rotated at 3000 rpm for 15 seconds. Then the substrate was rinsed twice with Nanopure water and dried with spinning (ca. 30 seconds). All routines for film fabrication were conducted under Cleanroom class 100 conditions to avoid contamination with dust microparticles usually observed when functionalized surfaces are exposed to ambient air.

For free-standing film fabrication, a method introduced by Kotov et al.^{[18]}, was used in which cellulose acetate (CA) is used as a sacrificial layer prepared as cast films. However, to enhance in-plane uniformity of the LbL films, spin-coating was used to apply the polymer layers to a spin-deposited ultrathin layer of CA on a silicon wafer. Free standing LbL films were prepared with the following operations: (a) spin coating the CA layer from a 1% acetone solution; (b) deposition of (PAH-PSS)ₙPAH multilayers with SA-LBL method; (c) deposition of gold nanoparticles with either spin-assisted or with conventional LbL assembly to reach a higher surface coverage, (d) additional deposition of (PAH-PSS)ₙPAH multilayers; (e) immersion the film on the substrate in acetone to dissolve the underlying CA layer. In the course of the release procedure, the ultrathin multilayered films containing gold nanoparticles with a general structure (PAH-PSS)ₙPAH/Au/(PAH-PSS)ₙPAH, were submerged in the acetone solution. These films were picked up with different solid substrates (usually copper grids with grid dimensions below 100 μm and a copper holder with a central hole of 600 μm in diameter) for further investigations. The SA-LBL films were investigated with atomic force microscopy (AFM) in the tapping mode with Nanoscope IIIA, Dimension 3000 and Multimode microscopes (Digital Instruments, Inc) according to the usual procedure adapted in our laboratory for ultrathin polymer films.^{[27]} Optical properties of gold nanoparticle solutions and the multilayered films on quartz substrates were measured with Shimadzu 1601 UV-visible spectrometer.

All films fabricated showed uniform surface morphology on a large scale (>10 μm across) with only few isolated large surface features and no corrugations and cracks (FIG. 1b). The microroughness of these films still located on the silicon substrate did not exceed 15 nm within the 10×10 μm surface area and was mainly caused by the gold nanoparticles with a diameter of 12.7 nm. UV-vis spectra for the multilayered films showed three major adsorption bands associated with PSS layers, as well as individual and collective surface plasmon resonances generated by gold nanoparticles embedded in a polymer matrix (FIG. 1c). The thickness of the films increased virtually linearly with the number of the polymer layers as expected for the multilayered LbL films. The minimum thickness achieved was 20 nm and it was limited by the presence of the gold nanoparticles as demonstrated in FIG. 1.

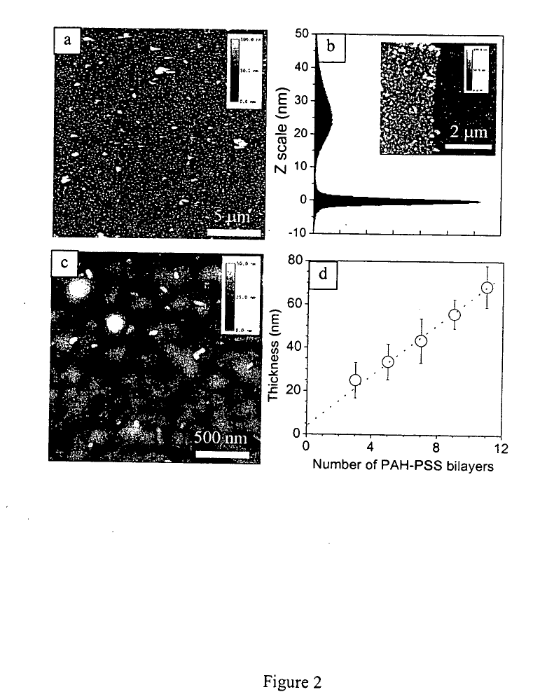

Atomic force microscopy (AFM) imaging of the SA-LbL free suspended films collected on a silicon wafer after release from the sacrificial layer revealed a smooth and uniform surface without large scale corrugations and wrinkles usually observed for conventional free standing composite LbL films (FIG. 2a). Moreover, the surface microroughness decreased slightly to 8-10 nm due to the surface relaxation after the film release. The lateral sizes of the undamaged pieces of the released film can reach 1 cm across. Higher resolution AFM images (FIGS. 2b, 2c) revealed an intralayer gold nanoparticle aggregation coated with the polymer multilayers in accordance with the microstructure sketch presented in FIG. 1. The thickness of these released films was measured with the AFM bearing analysis at the film edge areas (FIG. 2b). The height histogram confirmed very good uniformity and flatness of the released films on a large scale and the absence of any significant corrugations, a distinctive feature of the SA-LbL films in comparison with conventional free-suspended LbL films containing inorganic particles. The film thickness increased with a number of deposited layers and followed a linear relationship, a signature of well-ordered, multilayered films (FIG. 2d). The increment was measured to be close to 1.4 nm per polymer layer, which is in agreement with the results on conventional LbL PSS-PAH films on the solid substrates.

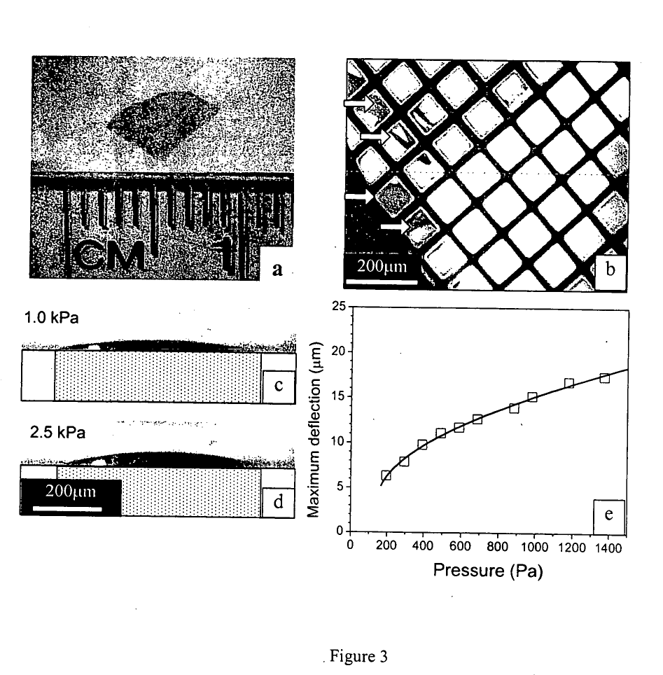

As discussed hereinbelow, the SA-LbL films submerged in acetone after release can be transferred onto the water surface. Although the films are less than 70 nm thick, they can be easily observed because of their light-blue color, which comes from the plasmon resonance of dense gold nanoparticles in the film as will be discussed in a separate publication.^{[21]} FIG. 3a shows the optical image of SA-LbL film with size around 4×4 mm floating on the water surface.

Several channel-containing or “holey” substrates like single-hole plates and normal copper grids can be used to pick up the films, which are very stable under normal condition without any support. When films are used to cover a 600 μm diameter hole no breaking or other damage occurs for at least a month. SA-LbL films suspended over smaller size holes, keep their characteristics for many months. FIG. 3b shows the image of SA-LbL film on the 200 mesh grid with the cell dimensions of 100×100 μm, which had been kept under normal condition for 3 months. The majority of the rectangular cells of the grid were covered with the uniform SA-LbL film, which is brighter than other areas due to the light reflection enhanced by the presence of the gold nanoparticle intralayer. At the left part of the image, several areas of the film were broken during the lifting process (see an arrow pointing on such an area). These free-standing films were very robust and could be stored under ambient conditions for several months without losing their elastic properties. The minimum overall thickness of the SA-LbL films we were able to release and transfer were about 20 nm. This includes the gold nanoparticles intralayer that is 12.7 nm thick and, thus, only about 9 nm of the surrounding polymer layers was contributed by 10-15 polymer chains (FIG. 1).

Despite this nanoscale thickness, the SA-LbL free-suspended films fabricated here were capable of sustaining significant and repeatable mechanical deformations as were probed with a bulging test as described in detail in literature.^{[17,22,23]} This test was performed with the free-standing film covering a 600 μm diameter hole by applying a hydrostatic pressure from one side to the film and detecting its deflection with an optical microscope (FIG. 1b). FIGS. 3c and 3d show the side view optical images of the SA-LbL film with two different pressures. The film deformation can be clearly observed with the film displacement reaching 50 μm for the pressure reaching 4.0 kPa. This displacement corresponds to the relatively high mechanical strain of up to 1.5%. This deformation was completely reversible and the film underwent a complete transformation into a flat state when the pressure was released. This test can be repeated in multiple cycles without damaging the free standing film. These results confirmed AFM observations discussed above regarding the high uniformity and integrity of extremely thin nanoparticle-containing films obtained with the SA-LbL assembly. Detailed studies accomplished in accordance with J. J. Vlasak et al., J. Mater. Res., 7, 3242 (1992) (Ref. 23), demonstrated that film deflection indeed followed a power law expected for the uniform elastic deformation of thin film as will be discussed hereinbelow (see data and fit in FIG. 3e).

These measurements show that the elastic modulus values can reach 30-40 GPa for elastic deformations as high as 2%. The ultimate tensile strength as high as 130 MPa was reached as well. Moreover, considering that without external pressure but under influence of external fluctuations (acoustic noise) the free-standing films show random deviations of about 1 μm with a frequency of about 5 Hz and are stable under these conditions for more than a month, a life time of about ten million cycles can be estimated. These are record parameters, which far exceed mechanical parameters reported to date and are close to that demonstrated for relatively thick (up to microns) nanofiber-reinforced LbL films, and far exceed mechanical parameters reported to date and are close to that demonstrated for relatively thick (up to microns) nanofiber-reinforced LbL films.^{[19]}

### REFERENCES

^{[1}] Y. Lvov, G. Decher, H. Möhwald, Langmuir 1993, 9, 481. Y. Lvov, K. Ariga, I. Ichinose, T. Kunitake, J. Am. Chem. Soc. 1995, 117, 6117. G. Decher, Y. Lvov, J. Schmitt, Thin Solid Films 1994, 244, 772. M. Yu, Y. Lvov, D. Decher, Crystallography Reports 1994, 39, 628. S. Y. Yang, M. F. Rubner, J. Am. Chem. Soc. 2002, 124, 5017. V. V. Tsukruk, V. N. Bliznyuk, D. Visser, A. L. Campbell, T. J. Bunning, W. W. Adams, Macromolecules 1997, 30, 6615. V. V. Tsukruk, Prog. Polym. Sci. 1997, 22, 247.
^{[2]} L. Cheng, J. A. Cox, Electrochem. Commun. 2001, 3, 285.
^{[3]} T. Serizawa, M. Yamaguchi, M. Akashi, Angew. Chem. Int. Ed. 2003, 42, 1115.
^{[4]} Y. Lvov, K. Ariga, I. Ichinose, T. Kunitake, Langmuir 1996, 12, 3038.
^{[5]} a) F. Caruso, R. A. Caruso, H. Möhwaid, Science 1998, 71, 2265. b) Y. Lvov, A. Antipov, A. Mamedov, H. Möhwaid, G. Sukhorukov, Nano Lett. 2001, 1, 125.
^{[6]} M. A. Correa-Duarte, M. Giersog, N. A. Kotov, L. M. Liz-Marzan, Langmuir 1998, 14, 6430.
^{[7]} Decher, G. Science 1997, 277, 1232.
^{[8]} N. Krasteva, I. Besnard, B. Guse, R. E. Bauer, K. Mullen, A. Yasuda, T. Vossmeyer, Nano Lett. 2002, 2, 551. V. V. Tsukruk, Adv. Mater. 2001, 13, 95.
^{[9]} J. Hiller, J. D. Mendelsohn, M. F. Rubner, Nature Mater. 2002, 1, 59. V. A. Sinani, D. S. Koktysh, B.-G. Yun, R. L. Matts, T. C. Pappas, M. Motamedi, S. N. Thomas, N. A. Kotov, Nano Lett. 2003, ASAP. Z. Tang, Y. Wang, N. A. Kotov, Langmuir 2002, 18, 7035. F. Caruso, R. A. Caruso, H. Möhwald, Chem. Mater. 1999, 11, 3309.
^{[10]} J. Cho, K. Char, J.-D. Hong, K.-B. Lee, Adv. Mater. 2001, 13, 1076.
^{[11]} P. A. Chiarelli, M. S. Johal, J. L. Carron, J. B. Roberts, J. M. Robinson, H.-L. Wang, Adv. Mater. 2001, 13, 1167.
^{[12]} P. A. Chiarelli, M. S. Johal, D. J. Holmes, J. L. Casson, J. M. Robinson, H.-L. Wang, Langmuir 2002, 18, 168.
^{[13]} B.-H. Sohn, T.-H. Kim, K. Char, Langmuir 2002, 18, 7770.
^{[14]} S. V. Yablonskii, K. Nakano, A. S. Mikhailov, M. Ozaki, K. Yoshino, Jpn. J. Appl. Phys. 2003, 42, 198.
^{[15]} M. H. Lim, D. G. Ast, Adv. Mater. 2001, 13, 718.
^{[16]} W. T. S. Huck, A. D. Stroock, G. W. Whitesides, Angew. Chem. Int. Ed., 2000, 39, 1058. A. D. Stroock, R. S. Kane, M. Weck, S. J. Metallo, G. M. Whitesides, Langmuir 2003, 19, 2466.
^{[17]} H. Xu, F. Heger, F. Mallwitz, M. Blankenhagel, C. Peyratout, W. A. Goedel, Macromol. Symp. 2002, 177, 175. F. Mallwitz, W. A. Goedel, Angew. Chem. Int. Ed. 2001, 40, 2645. W. A. Goedel, R. Heger, Langmuir 1998, 14, 3470.
^{[18]} A. A. Mamedov, N. A. Kotov, Langmuir 2000, 16, 5530.
^{[19]} A. A. Mamedov, N. A. Kotov, M. Prato, D. M. Guldi, J. P. Wicksted, A. Hirsch, Nature Mater. 2002, 1, 190. Z. Tang, N. A. Kotov, S. Magonov, B. Ozturk, Nature Mater. 2003, 2, 413.
^{[20]} S. T. Dubas, T. R. Farhat, J. B. Schlenoff, J Am. Chem. Soc. 2001, 123, 5368.
^{[21]} C. Jiang, S. Markutsya, V. V. Tsukruk, Langmuir submitted.
^{[22]} J. W. Beams, in Structure and Properties of Thin Solid Films, (Eds: C. A. Neugebauer, J. B. Newkirk, D. A. Vermilyea), John Wiley: New York 1959, p 183.
^{[23]} J. J. Vlasak, W. D. Nix, J Mater. Res. 1992, 7, 3242.
^{[24]} Grabar, K. C.; Freeman, R. G.; Hommer, M. B.; Natan, M. J. Anal. Chem. 1995, 67, 735.
^{[25]} C. Jiang, S. Markutsy, V. V. Tsukruk, Polymer Materials: Sci. & Eng. 2003, 89, 346.
^{[26]} V. V. Tsukruk, V. N. Bliznyuk, Langmuir 1998, 14, 446.
^{[27]} V. V. Tsukruk, Rubber Chem. Technol. 1997, 70, 430. V. V. Tsukruk, D. H. Reneker, Polymer, 1995, 36, 1791.

### EXAMPLE 2

### Collective and Individual Plasmon Resonances in Nanoparticle Films Obtained by Spin-Assisted Layer-by-Layer Assembly

Experimental

Reagents and Materials. Polymer for LbL assembly, namely, poly(ethylene imine) (PEI, M_{w}=25 000), poly(allylamine hydrochloride) (PAH, M_{w}=65 000), and poly(sodium 4-styrenesulfonate) (PSS, M_{w}=70 000) were purchased from Aldrich and used without further purification. Ultra-pure water with a resistivity of 18 MΩ·cm used in all experiments was purified with a Nanopure® system. Quartz substrates were cleaned with a fresh Royal solution (HNO₃:HCl, V:V=1:3). Silicon wafers cut to a typical size of 10×20 mm were cleaned in a piranha solution (H₂SO₄:H₂O₂, V:V=1:3), according to a usual procedure adapted in our laboratory.^{[33]} Attention: Royal and Piranha solutions are extremely dangerous and should be very carefully treated. Silicon wafers of the {100} orientation with one side polished (Semiconductor Processing, Co.) and quartz plates with both sides polished (Chemglass Co.) were atomically smooth. After cleaning, the substrates were then rinsed thoroughly with Nanopure water and dried with dry nitrogen before used.

Fabrication of gold nanoparticles/LbL multilayers. Gold nanoparticles of different diameters from 2 to 25 nm were prepared according to the known procedure described in the literature.^{[34,35]} Small size particles were synthesized by using thiocyanate as a reducing agent, while larger nanoparticles were obtained by using sodium citrate. For example, particles with 12.7 nm diameter used throughout in this study were synthesized as follows: 5 mL 1% sodium citrate solution was quickly injected into 50 mL of 1 mM HAuCl₄ boiling solution. The solution was kept under boiling conditions for 10 min and continuously stirred for an additional 15 min. Gold nanoparticle solutions were stored at room temperature in a dark area and used within 3 weeks. Sodium citrate left in the solution after the synthesis of gold particles surrounds the gold nanoparticles so that they are quite stable in solution. These nanoparticles bear modest negative charge under normal pH conditions.^{[16,36]}

For initial modification of the silicon surface, freshly cleaned substrates were first immersed in 1% PEI solution for 15 min to form a polyelectrolyte monolayer with a thickness of about 1 nm. After activation with HCl solution, the slightly positively charged substrates were immersed in gold nanoparticle solution for a certain time period ranging from 1 to 30 min to facilitate electrostatically driven adsorption. Then, the substrates were rinsed with pure water to remove the loosely tethered particles.

The multilayered films with different thicknesses were fabricated by the spin-assembly or spin-assisted LbL (SA-LbL) method, which is a combination of spin-coating and conventional LbL techniques. Spin-assisted LbL technique has been recently introduced as a time- and cost efficient assembly and successfully applied to a range of polyelectrolytes and nanoparticles.^{[37,38]} The thickness of the deposited layers can be controlled by solvent evaporation, spin speed, spin time, and solute concentration.^{[39]} We applied SA-LbL to construct polymer multilayers and nanoparticle-containing layers with low density of nanoparticles. However, conventional LbL was exploited to deposit high-density nanoparticle interlayers. This way, we fabricated [Au(PAH-PSS)ₙPAH]ₘ films as presented in FIG. 4. According to usual LbL terminology, n (ranging from 0 to 15) corresponded to the number of polymer bilayers and m (ranging from 1 to 3) corresponded to the number of gold nanoparticle/polymer bilayers. Polyelectrolytes were dissolved in Nanopure water with 0.2% concentration. In the course of SA-LbL fabrication, a droplet of 150 μL polyelectrolyte solution was dropped on the silicon substrate and rotated for 20 seconds with 3000 rpm rotation speed. The substrates were rinsed twice by Nanopure water and dried while spinning for 30 seconds. This procedure was repeated until a designed number of the bilayers n was achieved. All SA-LbL films were prepared in a class 100 clean room to avoid contamination and to assure high optical quality of the films. Fabrication time of about 2 minute per bilayer resulted in very time-efficient procedure: films with 10-20 bilayers were fabricated within 20-40 minutes instead of usual 5-10 hours with manual or robotic arm routines.

Optical properties of gold nanoparticle solutions and multilayered SA-LbL films on quartz substrates were measured with Shimadzu 1601 UV-visible spectrometer. Structure characterization was conducted with atomic force microscopy (AFM). AFM topographical and phase images were collected with Dimension or Multimode AFM microscopes (Digital Instrument) in the tapping mode under ambient condition in accordance with a usual procedure adapted in our laboratory.^{[40]} Silicon tips with spring constants of 50 N/m were used for most scans. Tip radii were in the range of 20-40 nm as calculated from the profiles of a reference gold nanoparticle standard.^{[41]} For selected high-resolution images, carbon nanotube tips with tip radius of 5-11 nm (Nanodevices) were used. AFM images were obtained on different scales ranging from 500 nm to 50 μm with a scanning rate of 1 Hz. To obtain the surface microroughness, a 1×1 μm surface area was normally measured. A film thickness was routinely obtained from the bearing analysis of the surface areas with a scratch produced by a sharp steel needle. Independently, the thickness of the polymer multilayers was measured with a Compel Ellipsometer (InOmTech, Inc.). The average thickness of the SiO₂ layer was measured prior to the polymer deposition and used for the analysis of the ellipsometry data with a double-layer model.^{[42]} The refractive indices for polymers and silicon oxides were taken from literature.^{[43,44]} However, it is worth noting that due to the strong absorption, the thickness of films with high-density gold particles cannot be obtained easily from ellipsometry measurement.

Results and Discussions

Monolayer of Gold Nanoparticles. From the analysis of AFM images of the gold nanoparticles, the mean diameter was estimated from surface histograms constructed for at least 50-100 nanoparticles (FIG. 5). After analyzing size distribution and optical properties for several batches of gold nanoparticles with a diameter ranging from 2 nm to 25 nm, for further studies the nanoparticles with the average diameter of 12.7±1.3 nm were selected (FIG. 5c). The nanoparticle diameter and its variation (˜10%) were close to the results from Grabar et al.^{[34]} This selection gave us nanoparticles of reasonable solution concentration, high storage life-time, relatively narrow size distribution, and clear optical response.

The final concentration of gold in the solution was close to 1 mmol/L. Therefore, the aggregation number per particle was about 6×10⁴ and the concentration of gold nanoparticles was about 1.5×10⁻⁸ mol/L assuming a complete reaction. UV-visible spectra of these solutions displayed a strong plasmon resonance peak around 519±0.5 nm caused by SPR of individual nanoparticles (FIG. 5d).^{[45,46]} This strong absorption gives the solution of gold nanoparticles characteristic intense burgundy color.

Gold nanoparticles are rarely adsorbed on a bare silicon surface due to unfavorable Coulombic interactions (both surfaces are slightly negatively charged): only 40-50 nanoparticles were found in the surface area of 10×10 μm. The modification of the silicon surface with a positively charged PEI monolayer resulted in efficient, electrostatically driven adsorption of gold nanoparticles: 1200 nanoparticles were found within 1×1 μm on the PEI surface. Additional surface activation by 0.01 mol/L HCl solution resulted in significant increase of the surface coverage: 1800 gold nanoparticles were found within the 1 μm² surface area.

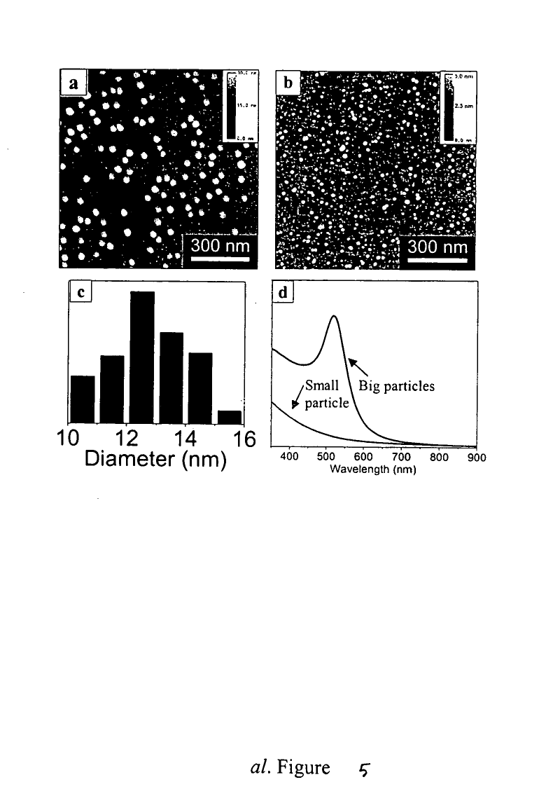

To control the gold nanoparticle density (surface coverage and interparticle distance) during the deposition, the assembly on the PEI monolayer was stopped by a “sudden dilute” technique and the substrate was then rinsed and dried. Increasing the deposition time resulted in the higher surface coverage increasing from 250 nanoparticles/μm² for short deposition time up to a saturation limit of 1800 particles/μm². The concentration of gold nanoparticles solution is the most important factor affecting the surface coverage (FIG. 6). For the lowest surface coverage tested here, the mean distance between nanoparticles was about 88 nm that exceeded their diameter manifold (distance:diameter ratio of 7:1). For the medium surface coverage of 5-10%, the interparticle distance decreased to 40-50 nm (distance:diameter ratio of 4:1). Finally, at the saturation level, a virtually “complete monolayer” of gold nanoparticles became visible on AFM images (FIGS. 6c and 6d). Large-scale AFM images showed a smooth, high quality surface with microroughness below 5 nm and absence of microscopic bumps originating from external contaminations. However, this smooth surface morphology at high magnification represented a common AFM artifact associated with tip dilation of the lateral dimensions of nanoscale objects.^{[47]} Misleading AFM images of “complete” monolayers should be treated with great care. This effect is demonstrated in FIGS. 6e and 6f, displaying two high-resolution AFM images of the gold nanoparticles obtained with an ordinary silicon tip and a carbon nanotube tip. The dilation effect was much smaller (but still present) on the AFM image obtained with the nanotube tip that allowed evaluation of nanoparticle concentration for the highest surface coverage. This corresponded to the surface coverage of 22% and the average interparticle distance of 26 nm or 2:1 distance-diameter ratio. This distance falls in the range where effective collective SPR between neighboring nanoparticles is expected. Achieving higher surface concentration under these conditions was prevented by repulsive interactions among nanoparticles. This value was relatively high considering that maximum achievable surface coverage that produces 1:1 distance:diameter ratio for different symmetries of particles is within 75-91% and the percolation limit for spherical particles is close to 55%.^{[48]} These parameters can only be reached for lightly charged nanoparticles.^{[4]}

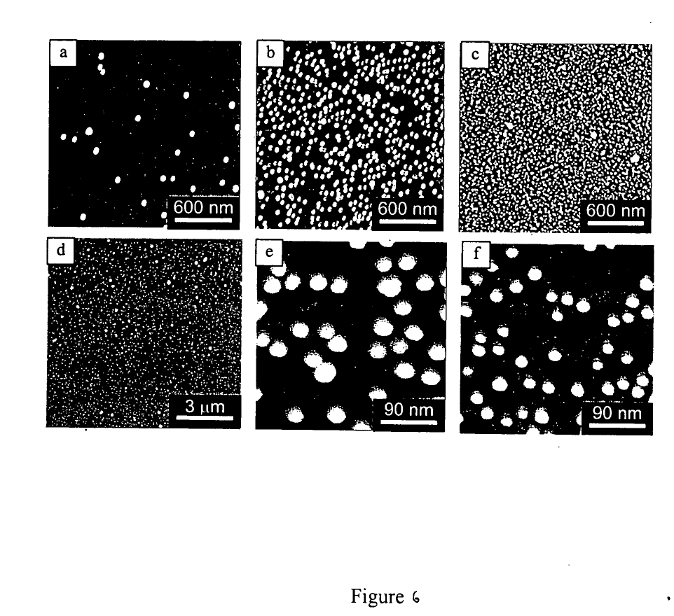

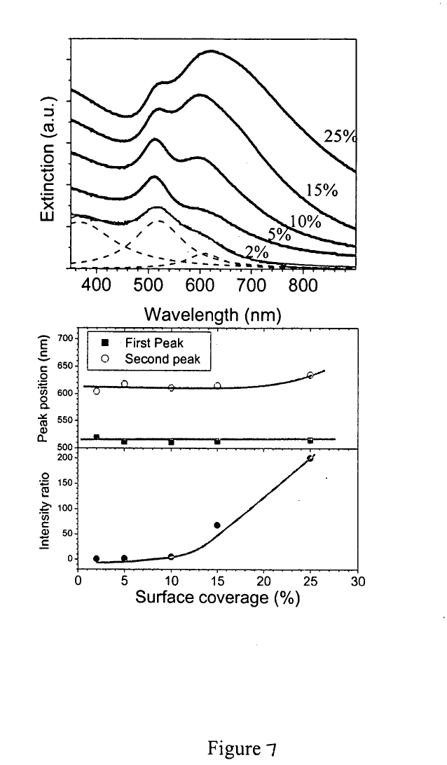

FIG. 7 shows the UV-visible extinction spectra of gold nanoparticle monolayers with different surface coverages. Unlike the spectrum for solution in FIG. 5, two broad peaks were observed in the region of 500 to 700 nm. These peaks could be clearly separated after background subtraction and fitting with Lorentzian functions as demonstrated for one spectrum in FIG. 7. The strong and sharp extinction peak, which appeared around 518±0.5 nm with the width of 53 nm, was virtually unchanged for all monolayers and was caused by the plasmon resonance of isolated gold nanoparticles similarly to dilute solutions. The height of this peak showed almost linear increase with the increase of the surface density.

Another broad peak appeared around 615 nm at low surface concentration and was red-shifted to 635 nm for the highest surface coverage (FIG. 7). The appearance of this second peak is associated with interparticle resonances, which strongly depend upon the distance:diameter ratio among other factors.^{[28,14,49,50]} The absorption at this wavelength was very minor for low surface coverage when the distance:diameter ratio was relatively high (4:1 to 7:1) and increased dramatically for the higher surface coverage. It became predominant (integral intensity is 200 higher for the second peak than the first peak) for the 22% surface coverage when the distance:diameter ratio decreased to 2:1. In fact, such a shape was predicted for a pair of nanoparticles when the distance:diameter ratio falls below 2:1 but it is not usually observed because of low surface coverage achieved experimentally.^{[17,50]} A dominance of collective plasmon resonance was observed for monolayers with the distance:diameter ratio below 3:1 (FIG. 7).

Because of insufficient surface coverage and non-uniformity of interparticle distance distribution in a vast majority of experiments, only a gradual red-shifting of a broad peak is usually observed without separation of collective and individual resonances.^{[17]} In contrast, this broad peak was not originated from the red shift of the individual particle plasmon peak but had a composite nature and contained both individual and collective plasmon resonances.^{[50,51}] Collective surface plasmon band depends strongly on interparticle separation and, thus, is sensitive to the chemical environment of the particle and its interaction with surroundings.^{[36,50,52]} As shown below, nanoparticle-containing multilayers with sufficiently small interparticle distance produced a strong appearance of the distinctive collective resonance peak, which was sensitive to changing the inter-particle distance of gold nanoparticles within intra- and inter layered structures.

Gold Nanoparticles-Polymer Multilayer Films. The fabrication of the multilayered films began with the deposition of a first polymer bilayer on top of the gold nanoparticle monolayer (FIG. 4). FIG. 8 shows the AFM images of a gold nanoparticle array with PAH-PSS bilayer spin-assembled on top. A large-scale AFM image (10×10 μm) showed uniformity of this film with overall microroughness not exceeding 2.5 nm. Higher-resolution AFM image of the same layer, Au/(PAH-PSS)PAH, showed surface coverage similar to that measured before spin-assembly of top polymer layers. This indicated that the gold nanoparticles were strongly attached to the surface of the PEI monolayer and were not dissolved or washed away during the spin-coating and spin-rinsing.

The surface of the Au/(PAH-PSS)PAH film was relatively rough due to incomplete surface coverage with gold nanoparticles as indicated by significant surface microroughness. As can be seen from the line scan across the scratched film, the gold nanoparticle were covered by PAH-PSS bilayer resulting in a total thickness of nanoparticles aggregates of about 15 nm (the diameter of 12.7 nm+2.3 nm of PAH-PSS bilayer) (FIG. 8). The PAH-PSS bilayer thickness of 2.7 nm was independently obtained from the film areas without gold nanoparticles. The surface microroughness decreased with an additional deposition of the polymer bilayers. Indeed, for the sample Au/(PAH-PSS)₁₀PAH, where 10 bilayer were deposited, the multilayer film was very smooth with the microroughness well below 2 nm.

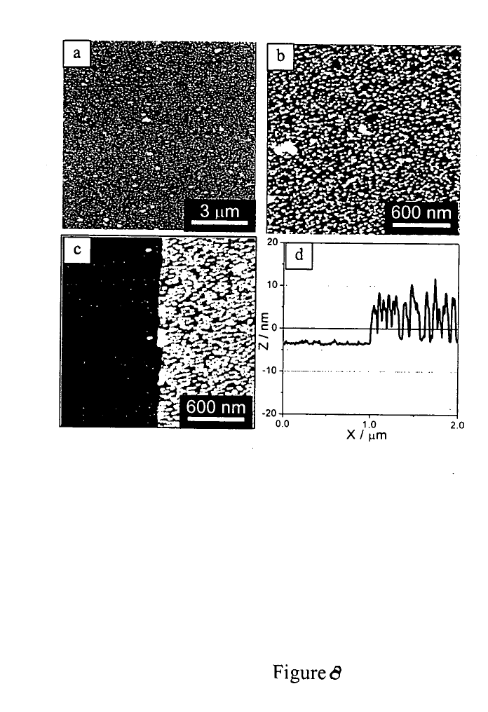

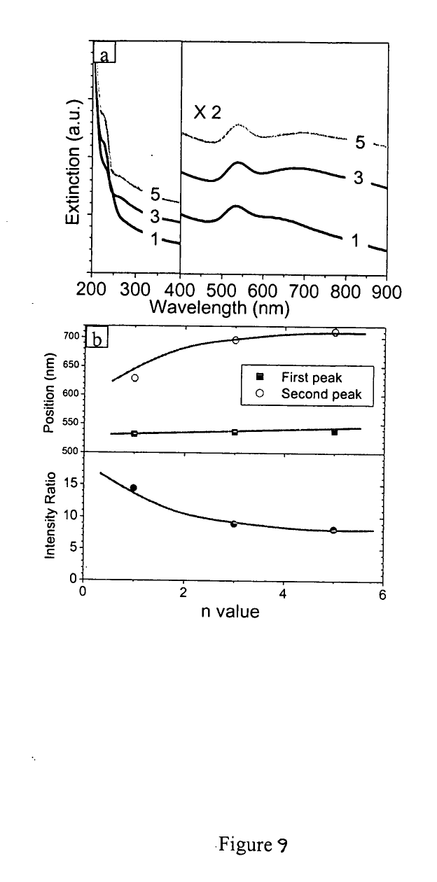

UV-visible spectra of Au/(PAH-PSS)ₙPAH multilayers measured for 5% surface coverage of gold nanoparticles revealed virtually constant intensity of the red-shifted first peak appearing around 535 nm with exact positions of 532±0.5, 536±0.5 and 538±0.5 nm for Au/(PAH-PSS)ₙPAH with n equal to 1, 3 and 5, respectively (FIG. 9). These peaks were 13 to 20 nm red-shifted compared to gold nanoparticle solution (519 nm). This red-shift was usually observed for the gold nanoparticles coated with a polymer layer or dissolved in different solvents and is caused by changing dielectric environment.^{[53,54]} For a matrix with a large refractive index, the position of the surface plasmon band would shift to longer wavelength.^{[30]} With increasing the bilayer number, thicker films covering the gold nanoparticle resulted in the further red-shift of the adsorption peak. It should be noted that the second peak for Au/(PAH-PSS)ₙPAH multilayers changed similarly (FIG. 9). With a larger number of polymer layers deposited on the gold nanoparticles, the intensity increased and the peak was further red-shifted. This can also be explained by the changing interparticle interaction because of the added dielectric layers. However, collective resonance was much more sensitive to the environment composition because red-shifting was more pronounced with the position changing from 630 nm to 720 nm (FIG. 9). Finally, a strong absorption peak appearing around 225 nm was caused by the contribution from the PSS chains and was used here for independent control of polymer layer deposition.^{[37]} The linear increase of that peak with the number of deposited layers was another strong evidence of the multilayer fabrication despite sparse arrangement of the gold nanoparticles.

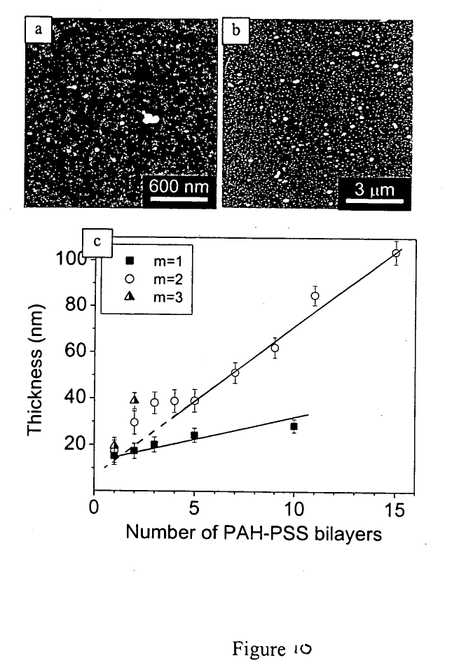

As a next step, multilayered films were made containing two and three gold layers designed as presented in FIG. 4. Both large-scale and higher-resolution AFM topography images of [Au/(PAH-PSS)₅PAH]₂ films with a high density of gold nanoparticles possessed microroughness of 4 nm within 1×1 μm surface areas and a film thickness of 40 nm. The thickness of the multilayered films [Au/(PAH-PSS)ₙPAH]ₘ changed linearly with the number of polymer bilayers for different combinations of gold nanoparticles and polymer layers for larger n (FIG. 10). Deviations from linear behavior observed for a small number of bilayers can be explained by partially filling the polyelectrolyte into the empty space between the gold nanoparticles. The linear increase is a strong evidence of the formation of the multilayered structure in the films. The slope of the thickness dependence upon a number of polymer bilayers gives the average PAH-PSS bilayer thickness of 3.2 nm in the [Au/(PAH-PSS)ₙPAH]₂ film for larger n. This value is close to the estimated thickness of the first bilayer (2.7 nm as discussed above) and corresponds to the results of ellipsometry measurement of (PAH-PSS)ₙ multilayers, which were spin-assembled without gold nanoparticles.^{[25]}

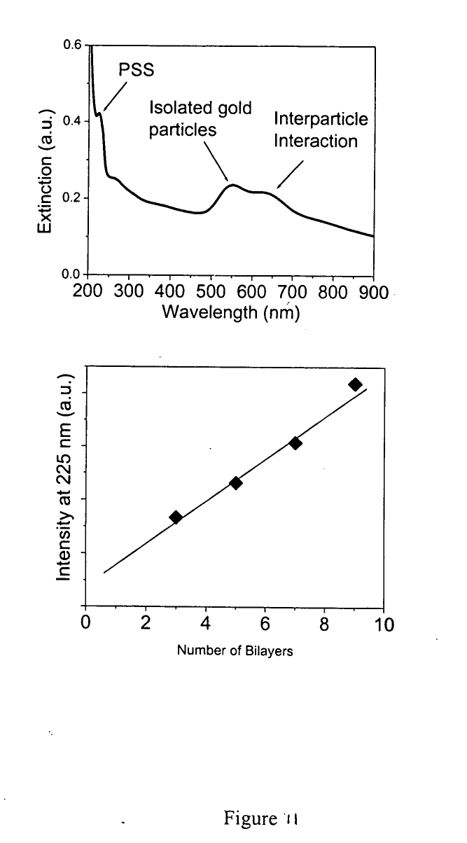

UV-visible spectrum of the gold nanoparticle-polymer films with high density of gold nanoparticles (22% surface coverage) is shown in FIG. 11. Three clear peaks can be obviously observed for [Au/(PAH-PSS)ₙPAH]₂ film. The peak at 225 nm showed a linear increase of the PSS material with increasing number of deposited bilayers (FIG. 11b). The intensity of strong plasmon resonance of individual nanoparticles at 540 nm was twice that for [Au/(PAH-PSS)ₙPAH] films with a single gold nanoparticle layer, which indicates good reproducibility in the deposition of the second gold-containing layer. The strong collective resonance peak appeared at 640 nm. This peak was also observed for gold nanoparticle monolayers and was associated with interparticle interactions within the layer (intralayer resonance). One can expect that an additional contribution associated with additional interactions between the gold nanoparticles located in adjacent layers (interlayer resonance) can be detected for some multilayer combinations. Such separate contribution are not experimentally observed for such small nanoparticles due, probably, to the masking by very strong intralayer resonance. Thus, a series of multilayers was fabricated with increasing number of polymer bilayers between gold intralayers to assure different intra- and inter-layer spacings that can be instructive in separation of inter- and intra-layer resonance contributions.

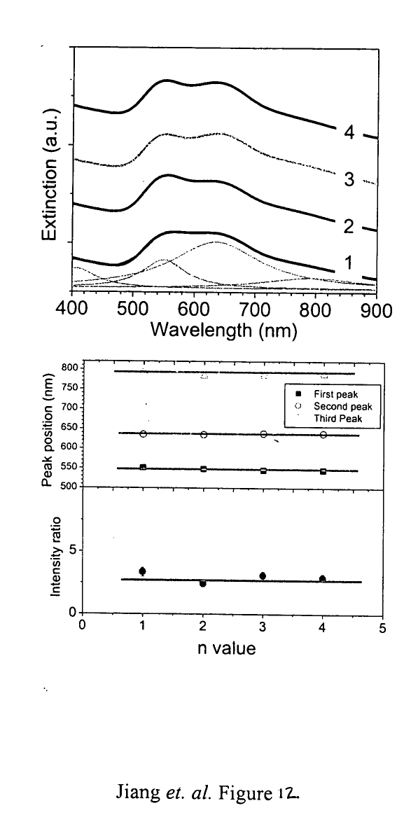

The UV spectra of the [Au/(PAH-PSS)ₙPAH]₂ multilayers with two layers containing 22% gold nanoparticle separated by the polymer interlayer with different thicknesses (n varied from 1 to 4 that corresponds to the thickness changing from 6.6 nm to 27 nm) showed two clear major peaks with a significant long-wavelength contribution around 800 nm appeared during fitting analysis (FIG. 12). Similar results were obtained for films containing three gold nanoparticle layers [Au/(PAH-PSS)ₙPAH]₃. A plasmon band of isolated gold nanoparticles in these films was further red-shifted due to the presence of additional polymer layers and appeared around 548 nm. The collective plasmon resonance peak appeared in the range of 630-640 nm, as was observed before. This peak is very broad with long-lasting right shoulder (FIG. 12).

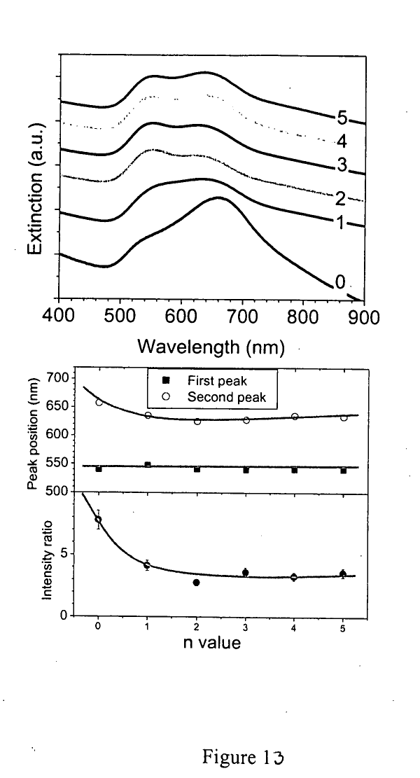

Similar spectra were observed for the [Au/(PAH-PSS)ₙPAH]₂ film with lower concentration of gold nanoparticles (FIG. 13). For the film with a single polymer layer between the two gold nanolayers (n=0), we observed a very strong plasmon peak at 656 nm with its intensity 8 times higher than the intensity of individual plasmon resonance. Increasing a separation between gold-containing nanolayers caused decreasing intensity and a blue-shift of this peak (FIG. 13). The position of this maximum and its intensity became similar to that observed for the gold nanoparticle monolayer only when distance between layers increased above distance:diameter ratio of 2:1.

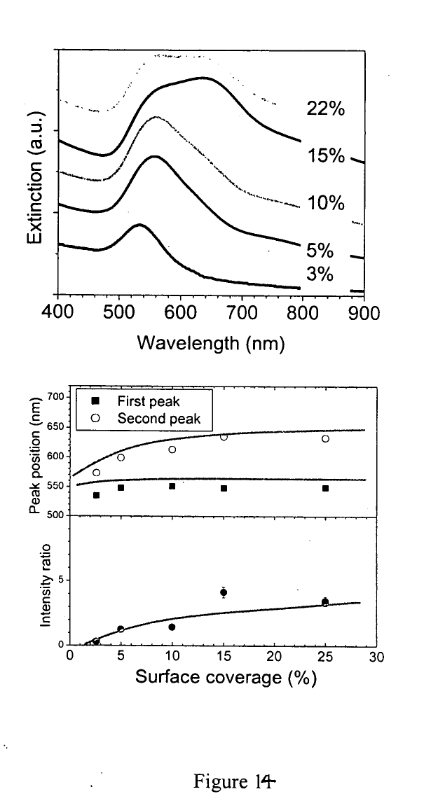

To clarify this behavior and verify the nature of observed long-wave resonance, several new [Au/(PAH-PSS)ₙPAH]₂ films with gold layers separated by three polymer layers (about 7 nm thick) were prepared by using solutions with different concentrations of gold nanoparticles (FIG. 14). Indeed, only an individual plasmon peak was observed for the multilayers with an average intra-layer distance:diameter ratio between 4:1 and 7:1. Obviously the very low overall concentration of gold nanoparticles was not sufficient to generate any collective resonances. For multilayers with a higher concentration of gold nanoparticles (distance:diameter ratio of 3:1 and lower), an additional contribution in the range of 600-660 nm showed up with a clearly separated second, red-shifted peak appearing for gold nanoparticle content of 15% and higher (distance:diameter ratio of 2.5:1 and 2:1) (FIG. 14). Optical data obtained for selected [Au/(PAH-PSS)ₙPAH]₃ films followed general trends described above.

However, what is more important is the-clear appearance of a long-wavelength contribution for higher concentration of gold nanoparticles, which showed up as a wide peak at 780-790 nm similarly to that appeared on the fitting result in FIG. 12 (FIGS. 12-14). The maximum contribution of this additional peak (reaching up to 40% of integral intensity) revealed for the multilayered film with two polymer bilayers between gold layers. This contribution decreased for both smaller and larger separations of gold layers to below 20% of integral intensity suggesting that the optimized interlayer distance of about 6 nm is required to enhance the appearance of interlayer resonance for the films studied here. These changes (intensity and maximum position) directly related to the variation of the interlayer spacing while the intralayer spacing remains unchanged directly suggest the presence of a strong contribution from interparticle resonances between gold nanolayers in addition to intralayer resonance discussed above. This phenomenon confirms the suggestion made above on the presence of the independent contribution originating from collective resonance between gold nanoparticles, which belong to different interlayers in the multilayer films (interlayer collective resonances) in addition to usually observed intralayer collective resonances.

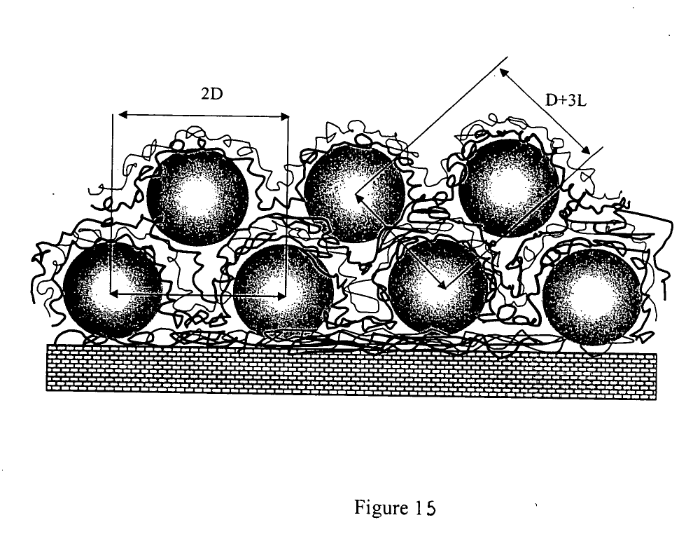

Film microstructure and optical properties. The results on optical properties presented above can be understood considering the real microstructure of gold multilayers derived from AFM data. The sketch of [Au/(PAH-PSS)ₙPAH]₂ film with the distance:diameter ratio of 2:1 is presented in FIG. 15. The formation of bi-layered gold films with incomplete surface coverage and a small number of polymer bilayers in-between inevitably goes through a stage of “filling” of the “empty” space available within the first deposited gold nanoparticle monolayer. In this case, the polymer layers form shells around gold nanoparticles with the thickness controlled by a number of bilayers in the manner presented in FIG. 15. Estimated total thickness of the two layer gold nanoparticle film with three polymer layers between them and parameters obtained from experimental data is about 32 nm, which is fairly close to the experimental result of 38 nm (FIG. 10).

For this microstructure, distance:diameter ratio is determined by equation 1+nL/D where L is the thickness of a polymer layer and D is the diameter of gold nanoparticles. Considering that, for a small number of layers, the thickness of the individual polymer layer is about 1.4 nm, we can estimate distance:diameter ratio for this microstructure to be close to 1.3:1. For this ratio, a strong collective resonance contribution in the range of 800 nm was both predicted theoretically and observed experimentally for metal nanoparticles with larger diameters.^{[28,55]} In thicker films, gradual increase of the separation between gold-containing layers causes an increasing distance:diameter ratio to values close to intralayer values and, thus, gradual disappearance of this contribution for thicker films. It is obvious that achieving higher nanoparticle density and reaching its theoretical percolation limit of 55% for 2D systems of short-range ordered spherical objects^{[56,57]} should result in a much stronger interlayer collective resonance contribution and clear separation of intralayer and interlayer contributions that is a subject of current investigation. Such a phenomenon, if achieved, can be critical for opto-mechanical sensing applications of gold-containing multilayer films that rely on the detection of changes of local intralayer and interlayer microstructures.

In accord with the present invention, organized multilayer films from inert metal nanoparticles and polyelectrolyte multilayers have been fabricated very time efficiently with LbL and spin-assisted LbL assembly techniques. SA-LbL films [Au/(PAH-PSS)ₙPAH]ₘ with different designs possessed well organized microstructure with uniform surface morphology and high optical quality.

The present invention thus provides compliant, highly-uniform, robust, smooth, and long-living free standing LbL films with record high mechanical parameters. These are true nanoscale films with an overall thickness ranging from 20 to 70 nm for films with a different number of layers. These free-standing films can be manufactured very time-efficiently with SA LbL assembly with an exceptionally high level of uniformity and integrity. These properties facilitate their ability to sustain multiple elastic deformations unachievable for the multilayered films fabricated with conventional LbL techniques. These unexpected properties are believed to be due to different conformation of the macromolecules adsorbed under the conditions of the shear stresses and adapting a much more spread state allowing for more uniform in-plane coverage of the stratified interfaces. The parameters achieved here for these nanoscale free-standing films (the elastic modulus of 30-40 GPa, the ultimate strain of 2%, and the ultimate tensile strength of 130 MPa) surpass those known for much thicker nanoparticle-containing free standing LbL films reported to date and possess a life time of millions of deformational cycles.

All SA-LbL films showed the strong extinction peak in the range of 510-550 nm, which is due to the plasmon resonance of the individual gold nanoparticles red-shifted because of a local dielectric environment. For films with sufficient gold nanoparticle density within the layers (10-22%), the second strong peak was consistently observed between 620-660 nm, which is due to the collective plasmon resonance from intralayer interparticle coupling. Finally, under certain conditions, interlayer interparticle resonance can be separated as an additional, independent contribution around 800 nm in UV-visible spectra. This observation was obtained for multilayer films with a conventional level of the dense surface coverage (that is within 10-20% surface coverage).^{[58]} The independent and concurrent detection of all individual, intralayer, and interlayer plasmon resonances for carefully designed multilayered films with higher content of gold nanoparticles achievable with LbL assembly can be critical for sensing applications which involve monitoring of opto-mechanical properties of these optically active films. The present invention thus provides a first example of robust, high-sensitive, free-suspended film of this type.

### EXAMPLE 2—REFERENCES

^{[4]}. Fendler, J. H. Chem. Mater. 2001, 13, 3196.
^{[14]}. Félidj, N.; Aubard, J.; Lévi, G.; Krenn, J. R.; Salerno, M.; Schider, G.; Lamprech, B.; Leitner, L. A.; Aussenegg, F. R. Phys. Rev. B 2002, 65, 075419.
^{[16]}. Caruso, F.; Spasova, M.; Salgueiriño-Maceira, V.; Liz-Marzán, L. Adv. Mater. 2001, 13, 1090; Westcott, S. L.; Oldenburg, S. J.; Lee, T. R.; Halas, N. J. Langmuir 1998, 14, 5396; Gittins, D. I.; Caruso, F. J. Phys. Chem. B 2001, 105, 6846.
^{[17]}. Schmitt, J.; Decher, G.; Dressick, W. J.; Brandow, S. L.; Geer, R. E.; Shashidhar, R.; Calvert, J. M. Adv. Mater. 1997, 9, 61.
^{[25]}. Decher, G. Science 1997, 277, 1232; Lvov, Y.; Ariga, K.; Ichinose, I.; Kunitake, T. J. Am. Chem. Soc. 1995, 117, 6117; Lvov, Y.; Decher, G.; Möhwald, H. Langmuir 1993, 9, 481; Decher, G.; Lvov, Y.; Schmitt, J. Thin Solid Films 1994, 244, 772; Lvov, Y.; Decher, D. Crystallography Reports, 1994, 39, 628.
^{[28]}. Rechberger, W.; Hohenau, A.; Leitner, A.; Krenn, J. R.; Lamprecht, B.; Aussenegg, F. R. Opt. Commun. 2003, 220, 137.
^{[30]}. Mulvaney, P. Langmuir 1996, 12, 788.
^{[31]}. Sastry, M.; Gole, A.; Patil, V. Thin Solid Films 2001, 384, 125.
^{[32]}. Taleb, A.; Petit, C.; Pileni, M. P. J. Phys. Chem. B 1998, 102, 2214.
^{[33]}. Tsukruk, V. V.; Bliznyuk, V. N. Langmuir, 1998, 14, 446.
^{[34]}. Grabar, K. C.; Freeman, R. G.; Hommer, M. B.; Natan, M. J. Anal. Chem. 1995, 67, 735.
^{[35]}. Johnson, S. R.; Evans, S. D.; Mahon, S. W.; Ulman, A. Supermolecular Sci. 1997, 4, 329.
^{[36]}. Malikova, N.; Pastoriza-Santos, I.; Schierhom, M.; Kotov, N. A.; Liz-Marzán, L. Langmuir, 2002, 18, 3694.
^{[37]}. Cho, J.; Char, K,; Hong, J.-D.; Lee, K.-B. Adv. Mater., 2001, 13, 1076.
^{[38]}. Chiarelli, P. A.; Johal, M. S.; Casson, J. L.; Roberts, J. B.; Robinson, J. M.; Wang, H.-L. Adv. Mater. 2001, 13, 1167.
^{[39]}. Chiarelli, P. A.; Johal, M. S.; Holmes, D. J.; Casson, J. L.; Robinson, J. M.; Wang, H.-L. Langmuir, 2002, 18, 168.
^{[40]}. Tsukruk, V. V.; Reneker, D. H. Polymer 1995, 36, 1791. Tsukruk, V. V. Rubber Chem. Techn. 1997, 70, 430. Ratner, B.; Tsukruk, V. V., Eds. Scanning Probe Microscopy of Polymers, ACS Symposium Series 1998, 694.
^{[41]}. Vesenka, J.; Manne, S.; Giberson, R.; Marsh, T.; Henderson, E. Biophysical J. 1993, 65, 992.
^{[42]}. Azzam, R. M. A.; Bashara, N. M. Ellipsometry and Polarized Light. Amsterdam; New York: North-Holland Pub. Co. 1977.
^{[43]}. Aranishi, Y.; Takahashi, H. Jpn. Kokai Tokkyo Koho 2000, 6.
^{[44]}. Van Krevelen, D. W. Properties of Polymers, Elsevier, Amsterdam, 1997.
^{[45]}. Bohren, C. F.; Huffman, D. R. Absorption and Scattering of Light by Small Particles; John Wiley and Sons: New York, 1983.
^{[46]}. Kreibig, U.; Vollmer, M. Optical Properties of Metal Clusters, Springer Press: Berlin, 1995.
^{[47]}. Magonov, S.; Whangbo, M.-H. Surface Analysis with STM and AFM, VCH, Weinheim, 1996.
^{[48]}. Karim, A.; Tsukruk, V. V.; Douglas, J. F.; Satija, S. K.; Fetters, L. J.; Reneker, D. H.;

Foster M. D. J. Phys., II, 1995, 5, 1441.
^{[49]}. Jensen, T. R.; Malinsky, M. D.; Haynes, C. L.; Van Duyne, R. P. J. Phys. Chem. B 2000, 104, 10549.
^{[50]}. Schmitt, J.; Mächtle, P.; Eck, D.; Höhwald, H.; Helm, C. A. Langmuir 1999, 15, 3256.
^{[51]}. Westcott, S. L.; Oldenburg, S. J.; Lee, T. R.; Halas, N. J. Chem. Phys. Lett., 1999, 300, 651.
^{[52]}. Ung, T.; Liz-Marzán, L. M.; Mulvaney, P. J. Phys. Chem. B 2001, 105, 3441.
^{[53]}. Mayya, K. S.; Schoeler, B.; Caruso, F. Adv. Funct. Mater. 2003, 13, 183.
^{[54]}. Huang, S.; Minami, K.; Sakaue, H.; Shigubara, S.; Takahagi, T. J. Appl. Phys. 2002, 92, 7486.
^{[55]}. Lal, S.; Westcott, S. L.; Taylor, R. N.; Jackson, J. B.; Nordlander, P.; Halas, N. J. J. Phys. Chem. B 2002, 106, 5609.
^{[56]}. Kooij, E. S.; Brouwer, E. A. M.; Wormeester, H.; Poelsema, B. Langmuir 2002, 18, 7677.
^{[57]}. Yu, A.; Liang, Z.; Cho, J.; Caruso, F. Nano Lett., 2003, 3, 1203.
^{[58]}. Schmitt, J.; Decher, G.; Dressik, W. J.; Brandow, S. L.; Geer, R.; Shashidar, R. Calvert, J. M. Adv. Mater., 1997, 9, 61.

All publications, patents and patent applications are incorporated herein by reference. While in the foregoing specification this invention has been described in relation to certain preferred embodiments thereof, and many details have been set forth for purposes of illustration it will be apparent to those skilled in the art that the invention is susceptible to additional embodiments and that certain of the details described herein may be varied considerably without departing from the basic principles of the invention.

1. A compliant free-standing multilayer membrane of the cross-sectional formula:
[(P_{cat}−Pₐₙ)ₙP_{cat}/Met/(P_{cat}−Pₐₙ)ₙP_{cat}]ₘ
wherein (P_{cat}−Pₐₙ) represents a bilayer of an anionic polymer and a cationic polymer between at least one layer of Met; n is about 1-50; m is about 1-10; Met is an inert metal nanoparticle; P_{cat} is a cationic polymer and Pₐₙ is an anionic polymer.

2. The membrane of claims 1 or 2 wherein Met is a gold or silver nanoparticle.

3. The membrane of claims 1 or 2 wherein m is about 1-3, and n is about 2-30.

4. The membrane of claims 1 or 2 wherein in P_{cat} is the acid addition salt of a polyamine, polyamide or polyimine.

5. The membrane of claims 1 or 2 wherein Pₐₙ is a salt of a polysulfonic acid, polyol, polycarboxylic acid or polyphenol.

6. The membrane of claims 1 or 2 wherein the membrane thickness is about 20-500 nm.

7. The membrane of claims 1 or 2 wherein the membrane thickness is about 20-80 nm.

8. The membrane of claims 1 or 2 wherein the nanoparticle is about 1-100 nm in diameter.

9. The membrane of claims 1 or 2 wherein the nanoparticle is about 10-20 nm in diameter.

10. The membrane of claim 1 which comprises about 1000-2000 Met per mm² of membrane.

11. The membrane of claim 4 wherein P_{cat} is polyallylamine hydrochloride.

12. The membrane of claim 5 wherein Pₐₙ is poly(sodium 4-styrene sulfonate).

13. The membrane of claims 1 or 2 which is prepared by a process comprising depositing layers of the P_{cat}, the Pₐₙ and the metal nanoparticles layer-by-layer using spin-assisted deposition onto the planar surface of a substrate.

14. The membrane of claim 13 wherein the surface has been pre-coated with a sacrificial layer of a nonionic polymer that is soluble in an organic solvent that does not dissolve Pₐₙ or P_{cat}.

15. The membrane of claim 14 wherein the nonionic polymer is a polysaccharide.

16. The membrane of claim 15 wherein the polysaccharide is a cellulosic polymer.

17. The membrane of claim 13 wherein the substrate is a silicon wafer.

18. The membrane of claim 14 further comprising releasing the membrane from the substrate by dissolving the nonionic polymer.

19. A detection cell comprising a chamber formed by capping a channel passing through a solid substrate at one end of the channel by the compliant membrane of claims 1 or 2, and by capping the channel at the other end by a rigid membrane that is transparent to energy sought to be detected.

20. The detection cell of statement 19 wherein the chamber is filled with a gas.

21. The detection cell of claim 20 wherein the gas is an inert gas or air.

22. The detection cell of claim 19 or 20 wherein the energy is photothermal energy.

23. The detection cell of claim 19 or 20 wherein passage of the energy through the rigid membrane and into the chamber, causes a detectable elastic reversible deflection of the compliant membrane.

24. The detection cell of claim 19 wherein the chamber is about 0.1-10 μm in diameter.

25. The detection cell of claims 19 or 20 wherein the solid substrate is polysilicon.

26. A planar solid substrate comprising a plurality of the detection cells of claims 19 or 20.

27. The detection cell of claim 19 or 20 wherein the solid substrate is less than about 100 nm in thickness.

28. The membrane of claim 1 which possesses an elastic modulus of about 10-50 MPa.

29. The membrane of claim 1 which exhibits high absorption in the 8-12 μm wavelength range.
